(19) United States
(12) Patent Application Publication
(10) Pub. No.: US 2016/0169306 A1
(43) Pub. Date: Jun. 16, 2016

(54) Reinforced Disc Brake Pad Backing Plate And Reinforced Brake Pad

(71) Applicant: Bendix Spicer Foundation Brake LLC, Elyria, OH (US)

(72) Inventors: Lonnie F. COOL, North Olmsted, OH (US); Harish RADHAKRISHNAN, Westlake, OH (US); Ryan S. HURLEY, Lakewood, OH (US)

(21) Appl. No.: 14/570,327

(22) Filed: Dec. 15, 2014

(51) Int. Cl. F16D 65/092

(52) U.S. Cl. CPC F16D 65/092

(57) ABSTRACT

A reinforced disc brake pad backing plate and brake pad are provided for use in a disc brake, including a disc brake of a commercial vehicle. The reinforced brake pad backing plate includes reinforcing material located at a radially-outer region of the backing plate that increases brake pad rigidity and provides a surface that facilitates insertion and removal of the brake pad during disc brake maintenance. The reinforcing material may extend axially away from the sides of the brake pad backing plate away from and/or toward the brake disc of the disc brake.

### BACKGROUND AND SUMMARY OF THE INVENTION

The present invention relates to disc brakes for vehicles, and in particular to an improved disk brake pad backing plate and brake pad.

Pneumatically-operated disc brakes have been undergoing development and deployment on commercial vehicles since at least the 1970's. Frequently, such brakes have included brake pads that were retained in the brake during vehicle operation by a retaining element installed over the radially outer or “top” edge of the brake pad. The retaining elements have included cross-bars mounted on the caliper in the region over the brake pads, spring plates captured between the brake caliper and the supporting caliper mount, brake calipers that obstruct brake pad removal (requiring removal of 50-100 lb. brake calipers during brake pad replacement), and other variations well known in the art.

Recently, a brake pad arrangement for commercial vehicle disk brakes has been developed that eliminates the need for any additional brake pad retaining hardware over the radially outer edge of the brake pad, while at the same time not requiring brake caliper removal. This design relies on cooperating brake pad retention features of the brake pad and the brake caliper mount to provide positive retention of the brake pad within the brake during operation, while also providing the ability for the brake pads to be removed through the caliper, i.e., without the need to remove the caliper. Examples of such a design are disclosed in U.S. Pat. Nos. 8,540,061 and 8,544,614.

While the above-identified brake arrangement without separate brake pad retention elements provides a substantial improvement in cost and ease of maintenance, as well as reduced brake component costs (elimination of extra hardware and fasteners), the insertion and removal of the brake pad through the in-place brake caliper requires grasping of the brake pad in a region of the caliper that does not offer an excess of finger or tool clearance. In addition, the brake pads heretofore used with such brakes have had planar pad backing plates.

The present invention improves maintenance and operation of brakes such as those identified above by providing a reinforced region at the radially outer edge of the brake pad backing plate. This reinforced region increases the torsional rigidity of the brake pad and suppresses bending during brake application, thereby increasing the frequency of vibration modes to suppress undesired brake pad-generated noise. The reinforced region also provides gripping surfaces that ease brake pad installation and removal and thereby lower physical stress on a technician's hands. Preferably, the reinforced region includes gripping depressions that further improve the ease of grasping the brake pad during removal and insertion. The gripping surfaces may also be through holes through the backing plate. If a through hole is present, then further grappling features would not be needed. The reinforcing region may be added to both stamped and cast brake pad backing plates.

The material added to the radially outer region of the brake pad backing plate may be located on the radially-outer edge of the backing plate, on a side of the backing plate facing away from the brake disc, or both. Further, if the radially outer edge of the reinforced region extends above a radially outer edge of the brake disc, the added reinforcing material may also extend outward from the side of the backing plate facing the brake disc.

Calculations have determined that the reinforcing material provides benefits in at least two regions of the brake pad. First, the addition of radially outer region material in the central portion of the brake pad (central relative to the circumferential direction of the brake disc) provides increased resistance to torsion/twisting due to the resulting increased polar moment of inertia, as well as more consistent pad lining-to-brake disc contact pressure in the center of the brake pads. The additional material in the central portion also changes the mode shape of the brake pad under vibration, resulting in a stiffer backing plate and a higher vibration frequency that may aid in suppressing brake noise (groaning and squealing). The added material and increased resistance to twisting/torsion also improves the dynamic pressure distribution across the brake pad.

In the lateral regions of the brake pad backing plate, in particular away from the center of the brake pad and preferably just above the pressure application point, the increased area moment of inertia provided by the added radially outer region material results in increased resistance to bending and a higher frequency response to vibration in the laterally-outer portion of the brake pad, resulting in more consistent contact pressure in the surrounding areas (and thus in turn, more uniform wear across the face of the brake pad lining material). The design also aids in suppressing brake pad-generated noise.

Preferably, the reinforced region material provides a sufficient thickness to permit the inclusion of depressions and/or holes in the brake pad backing plate to increase the availability of edge surfaces that may be gripped by a technician, either by fingers or a tool such as a hook, a lever or a gripping tool (e.g., a screwdriver or pliers), to aid in extraction and insertion of the brake pad from/to the brake. Such depressions and/or holes provide an ergonomically-friendly increase in grip as a result of the larger contact surface and better distribution of grip force, thereby minimizing any need for a “pinch grip” for pad removal, reducing worker fatigue in handling the brake pads, and helping decrease the amount of time and labor cost required for handling the brake pads during brake maintenance.

Preferably, the reinforcing material is distributed in the radially-outer region of the backing plate in both central and lateral portions of the backing plate, however, the present invention includes embodiments in which the reinforcing material is distributed in only one of such portions and/or only partially overlaps the central and/or lateral portions.

Other objects, advantages and novel features of the present invention will become apparent from the following detailed description of the invention when considered in conjunction with the accompanying drawings.

### BRIEF DESCRIPTION OF THE DRAWINGS

FIG. 1 is an oblique view of a disc brake pad backing plate having radially-outer a reinforced region in accordance with an embodiment of the present invention.

FIGS. 2a and 2b are elevation views of a brake disc-facing side and an opposite side of a disc brake pad backing plate similar to the brake pad backing plate in FIG. 1.

### DETAILED DESCRIPTION OF THE DRAWINGS

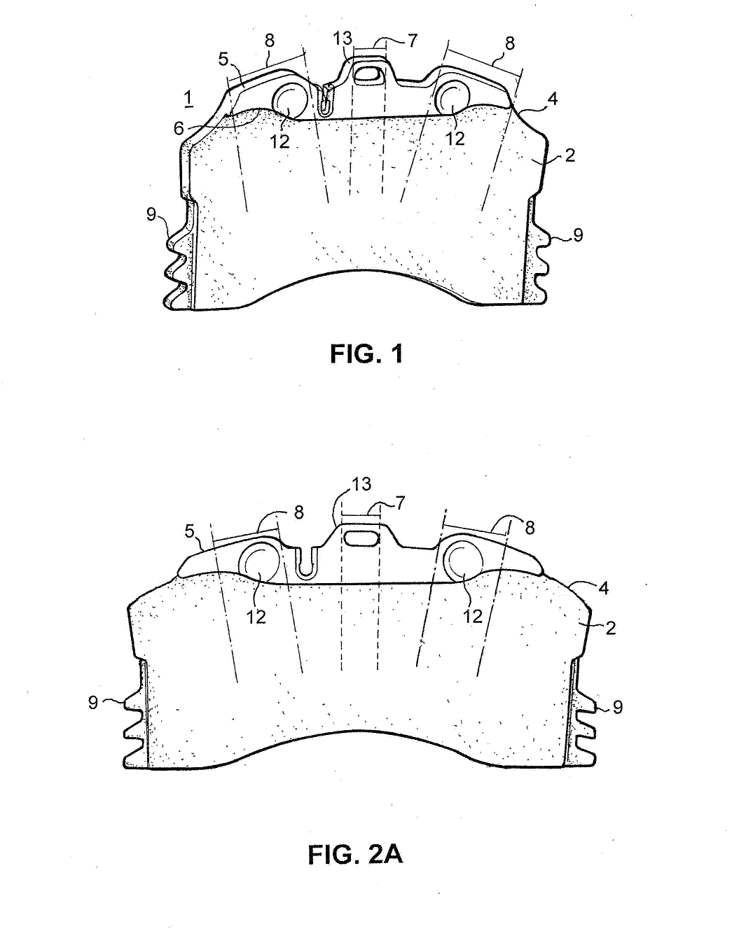

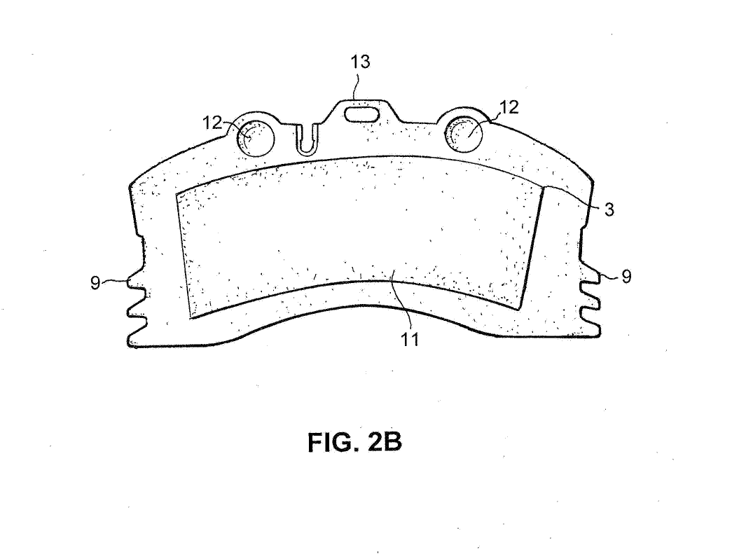

In the embodiment shown FIGS. 1 and 2a-2b, a brake pad backing plate 1 of a commercial vehicle disc brake is shown. The oblique view in FIG. 1 is of the side 2 of the backing plate 1 facing away from the brake disc (not illustrated) when the brake pad is in an installed position in the disc brake (not illustrated). At the radially outer region 4 of the generally planar backing plate 1 there is located reinforcing backing plate material 5 that extends both radially above the central region where the brake pad lining material would be located and axially away from the brake disc, forming a protruding ridge 6 in the central portion 7 and lateral portions 8 of the backing plate 1.

The reinforcing backing plate material 5 may be integrally formed with the backing plate 1 or may be added to the backing plate by any of several attachment methods well-known in the art (e.g., welding, riveting). A thickness in the axial direction may be on the order of 20% to 50% thicker than the lower section of the backing plate, in this embodiment approximately 9 mm as compared to a nominal backing plate thickness of 7 mm.

FIGS. 2a and 2b show elevation views of an embodiment that has the same general arrangements of that in FIG. 1, including the same lateral brake pad retaining features 9 that cooperate with corresponding retaining features of a brake pad carrier. FIG. 2a is a view of the brake pad backing plate side 2 facing away from the brake disc. FIG. 2b is a view of the brake pad backing plate side 3 facing toward the brake disc, including brake pad lining material 11 affixed to the backing plate 1.

In FIG. 2b the additional reinforcing material does not extend axially toward the brake disc beyond the face of side 3, however, additional reinforcing material may be located on this side of the brake pad backing plate area as long as additional reinforcing material would not contact the brake disc as the brake pad is advanced toward the brake disc throughout the service life of the brake pad.

In addition to the gripping surface provided by the protruding ridge 6, the illustrated embodiments include depressions 12 that provide additional gripping edge surfaces for gripping with fingers and/or a gripping tool. The depressions may be provided on both sides of the backing plate 1 as shown in FIGS. 2a and 2b, on only one of the two sides, or omitted completely. In this embodiment the depressions are 18 mm in diameter and approximately ⅓ the depth of the top portion of the backing plate, i.e., approximately 3 mm deep. This depth provides sufficient gripping surface while not locally reducing the backing plate thickness enough to unacceptably reduce the section modulus of the backing plate. The distance between the center of the depressions 12 allows for vertical motion of the pad in removal/installation while still maintaining the contour of the brake pad to fit within the caliper envelope.

The illustrated embodiments also include a further optional brake pad removal feature, a grappling feature 13 to facilitate ease of tool engagement during brake pad removal. Alternatively, a depression, alone or in combination with the illustrated laterally-disposed depressions 12, may be provided at the top center of the backing plate in lieu of, or in addition to, the grappling feature 13. The grappling feature is not limited to being a loop-shape, as long as a grappling tool can engage the feature to assist brake pad removal (for example, a loop, a ridge, an indentation and/or a square-edged feature).

The foregoing disclosure has been set forth merely to illustrate the invention and is not intended to be limiting. Because other such modifications of the disclosed embodiments incorporating the spirit and substance of the invention may occur to persons skilled in the art, the invention should be construed to include everything within the scope of the appended claims and equivalents thereof.

What is claimed is:

1. A reinforced brake pad for a disc brake, comprising:
a reinforced brake pad backing plate; and
brake pad lining material affixed to the brake pad backing plate,
wherein the reinforced brake pad backing plate includes
a radially-outer region and circumferentially-lateral regions relative to an axis of rotation of a brake disc of the disc brake when the reinforced brake pad is in an installed position in the disc brake,
a protruding ridge at the radially-outer region of the reinforced brake pad backing plate formed from reinforcing material at least one of integrally formed with and affixed to the backing plate, the protruding ridge extending from the radially-outer region of the reinforced brake pad backing plate at least one of in a direction away from the brake disc and toward the brake disc when the reinforced brake pad is in the installed position in the disc brake.

2. The reinforced brake pad of claim 1, wherein
the reinforced brake pad backing plate includes at least one depression in the reinforcing material configured to provide at least one brake pad removal gripping feature.

3. The reinforced brake pad of claim 1, wherein
the reinforced brake pad backing plate includes at least one grappling feature in the reinforcing material configured to provide at least one brake pad removal gripping feature.

4. The reinforced brake pad of claim 2, wherein
the reinforced brake pad backing plate includes at least one grappling feature in the reinforcing material configured to provide the at least one brake pad removal gripping feature.

5. The reinforced brake pad of claim 1, wherein
the reinforced brake pad backing plate includes at least one brake pad retaining feature located at at least one of the circumferentially-lateral regions of the reinforced brake pad.

6. The reinforced brake pad of claim 2, wherein
the reinforced brake pad backing plate includes at least one brake pad retaining feature located at at least one of the circumferentially-lateral regions of the reinforced brake pad.

7. The reinforced brake pad of claim 3, wherein
the reinforced brake pad backing plate includes at least one brake pad retaining feature located at at least one of the circumferentially-lateral regions of the reinforced brake pad.

8. The reinforced brake pad of claim 4, wherein
the reinforced brake pad backing plate includes at least one brake pad retaining feature located at at least one of the circumferentially-lateral regions of the reinforced brake pad.

9. A reinforced brake pad backing plate, comprising:
a plate structure having a radially-outer region and circumferentially-lateral regions relative to an axis of rotation of a brake disc of the disc brake when the reinforced brake pad backing plate is in an installed position in the disc brake,
a protruding ridge at the radially-outer region of the reinforced brake pad backing plate formed from reinforcing material at least one of integrally formed with and affixed to the backing plate, the protruding ridge extending from the radially-outer region of the reinforced brake pad backing plate at least one of in a direction away from the brake disc and toward the brake disc when the reinforced brake pad is in the installed position in the disc brake.

10. The reinforced brake pad backing plate of claim 9, further comprising:
at least one depression in the reinforcing material configured to provide at least one brake pad removal gripping feature.

11. The reinforced brake pad backing plate of claim 9, further comprising:
at least one grappling feature in the reinforcing material configured to provide at least one brake pad removal gripping feature.

12. The reinforced brake pad backing plate of claim 10, further comprising:
at least one grappling feature in the reinforcing material configured to provide at least one brake pad removal gripping feature.

13. The reinforced brake pad backing plate of claim 9, further comprising:
at least one brake pad retaining feature located at at least one of the circumferentially-lateral regions of the reinforced brake pad.

14. The reinforced brake pad backing plate of claim 10, further comprising:
at least one brake pad retaining feature located at at least one of the circumferentially-lateral regions of the reinforced brake pad.

15. The reinforced brake pad backing plate of claim 11, further comprising:
at least one brake pad retaining feature located at at least one of the circumferentially-lateral regions of the reinforced brake pad.

16. The reinforced brake pad backing plate of claim 12, further comprising:
at least one brake pad retaining feature located at at least one of the circumferentially-lateral regions of the reinforced brake pad.

17. The reinforced brake pad backing plate of claim 9, wherein
the protruding ridge having a thickness at least as thick as a thickness of the backing plate in a radially-inner region of the backing plate.

18. The reinforced brake pad backing plate of claim 17, wherein
the protruding ridge thickness is 20% to 50% thicker than the backing plate radially-inner region thickness.

19. The reinforced brake pad backing plate of claim 17, wherein
a thickness of the at least one brake pad removal gripping feature is the same as the protruding ridge thickness.
